(19) United States
(12) Patent Application Publication
(10) Pub. No.: US 2026/0368911 A1
(43) Pub. Date: Nov. 19, 2026

(54) MOTION DETECTION DEVICE, MOTION DETECTION METHOD AND NON-TRANSITORY MACHINE-READABLE MEDIUM THEREOF

(71) Applicant: SENAO NETWORKS, INC., TAOYUAN (TW)

(72) Inventors: Min-Lun CHEN, TAOYUAN (TW); Hsin-Chih YANG, TAOYUAN (TW); Wei-Siang WANG, TAOYUAN (TW)

(21) Appl. No.: 19/387,866

(22) Filed: Nov. 13, 2025

(30) Foreign Application Priority Data
May 14, 2025 (TW) 114118146

(51) Int. Cl. G06T 7/215; G06T 3/40; G06T 7/246

(52) U.S. Cl. CPC G06T 7/215; G06T 3/40; G06T 7/248; G06T 2207/10016; G06T 2207/30232

(57) ABSTRACT

A motion detection device performs the following operations on a current image frame and a previous image frame among the plurality of image frames: (A) performing a downscaling process; (B) generating a vector matrix through an optical flow algorithm; (C) determining a maximum value of the first region for a first region in the vector matrix, wherein the first region corresponds to a first regional threshold; (D) comparing the maximum value of the first region with the first regional threshold, and transmitting a motion detection signal to an alert unit when the number of times the maximum value of the first region exceeds the first regional threshold is greater than a count threshold. The alert unit is configured to provide an alert means based on the motion detection signal.

### CROSS-REFERENCE TO RELATED APPLICATIONS

This application claims priority to Taiwan Patent Application No. 114118146 filed on May 14, 2025, the entire contents of which are hereby incorporated by reference.

### BACKGROUND OF THE INVENTION

The present disclosure relates to a motion detection device, a motion detection method, and a non-transitory machine-readable medium thereof applied to continuous images. More particularly, the present disclosure relates to a motion detection device, a motion detection method, and a non-transitory machine-readable medium thereof for performing motion detection in continuous images using an optical flow algorithm.

In the technical field of continuous image recording (for example, Internet Protocol (IP) cameras), motion detection has become a practical feature that the manufacturers are actively investing in for development aside from general features of continuous image recording. With motion detection, a user can monitor whether a specific object (for example, a baby, a patient, a pet, a door, a cash register, or the like) in an image is related to a motion event. In addition, motion detection technology is also applicable to improving panning techniques, such as, but not limited to, panning features of a camera or camcorder targeting moving objects.

Motion detection involves real-time processing of continuous images and difference analysis between frames, and it often requires relatively high central processing unit (CPU) resources and high CPU specifications to perform. When related computation for motion detection is performed by a terminal device, delays may occur if the terminal device encounters a shortage of memory space or processing resources. Further, the inability to process image data in real time may cause the terminal device to overlook a critical scene, thereby degrading the quality of motion detection and further affecting the overall system reliability and user experience.

The aforementioned problem is particularly common in embedded systems, particularly Internet Protocol (IP) cameras, where their hardware components (for example, a processor, a memory, ports, and the like) often have relatively low specifications (for example, when compared with an ordinary camera or camcorder) to adapt to factors such as product size, application environment, network connection requirements, and manufacturing cost. Accordingly, these hardware constraints (for example, the processing speed of the processor, the capacity of the memory, and the number of ports) has placed many features of the embedded systems under development at a disadvantage.

In view of the foregoing, there is still an unmet need in the field to provide a real-time and efficient solution for motion detection processing of a camera or camcorder, particularly an embedded-system camera or camcorder (for example, an Internet Protocol (IP) camera), to reduce probability of motion detection delays and overlooked scenes effectively under relatively restrained hardware resource and specification of the system.

### SUMMARY OF THE INVENTION

In order to at least solve the above technical problems, the present disclosure provides a motion detection device. The motion detection device may comprise a storage, a processor, and an alert unit. The storage may be configured to store a plurality of image frames. The processor may be electrically coupled to the storage and the alert unit, and may be configured to perform the following operations on a current image frame and a previous image frame among the plurality of image frames: (A) performing a downscaling process; (B) generating a vector matrix through an optical flow algorithm; (C) determining a maximum value of a first region in the vector matrix, wherein the first region corresponds to a first regional threshold; and (D) comparing the maximum value of the first region with the first regional threshold, and transmitting a motion detection signal to the alert unit when a number of times the maximum value of the first region exceeds the first regional threshold is greater than a count threshold. The alert unit may be configured to provide an alert means based on the motion detection signal.

Optionally, the processor may be further configured to perform the following operations: (E) when the number of times the maximum value of the first region exceeds the first regional threshold is not greater than the count threshold, updating the current image frame and a subsequent image frame among the plurality of image frames as a new previous image frame and a new current image frame, respectively; and (F) repeating operations (A), (B), (C), (D), and (E) on the new current image frame and the new previous image frame until, for all corresponding image frames, the number of times that the maximum value of the first region exceeds the first regional threshold is greater than the count threshold, and, in turn, transmitting the motion detection signal to the alert unit.

Optionally, the processor may be further configured to convert, prior to generating the vector matrix, both the current image frame and the previous image frame into grayscale images.

Optionally, the vector matrix may comprise only the first region.

Optionally, the vector matrix may further comprise a second region in addition to the first region, and the second region may correspond to a second regional threshold. The processor may be further configured to determine a second regional maximum value of the second region, compare the maximum value of the second region with the second regional threshold, transmit the motion detection signal to the alert unit when a total number of times the maximum value of the first region exceeds the first regional threshold and a number of times the maximum value of the second region exceeds the second regional threshold, is greater than the count threshold.

Optionally, the motion detection device may further comprise a transceiver, wherein the transceiver may be electrically coupled to the processor, the transceiver may be configured to receive a set of control signals from an external device, and the processor may be further configured to determine the first regional threshold, the second regional threshold, and the count threshold based on the set of control signals.

Optionally, the processor may be further configured to determine a partitioning manner of the first region and the second region based on the set of control signals.

Optionally, the motion detection device may further comprise a transceiver, wherein the transceiver may be electrically coupled to the processor, the transceiver may be configured to receive a set of control signals from an external device, and the processor may be further configured to determine the first regional threshold and the count threshold based on the set of control signals.

Optionally, the alert unit may be a buzzer, and the alert means may be an audible buzzer alert.

Optionally, the alert unit may be a transceiver. The alert means may be an alert signal. The transceiver may be configured to transmit the alert signal to an external device and have the external device alert a user accordingly.

Optionally, the alert unit may comprise at least one indicator light, and the alert means may be a light-based alert.

In order to at least solve the above technical problems, the present disclosure further provides a motion detection method. The motion detection method may be executed by an electronic device, and may comprise performing the following steps on a current image frame and a previous image frame among a plurality of image frames: (A) performing a downscaling process; (B) generating a vector matrix through an optical flow algorithm; (C) determining a maximum value of a first region in the vector matrix, wherein the first region corresponds to a first regional threshold; and (D) comparing the maximum value of the first region with the first regional threshold, and, when the number of times the maximum value of the first region exceeds the first regional threshold is greater than a count threshold, providing an alert means.

Optionally, the motion detection method may further comprise the following steps: (E) when the number of times the maximum value of the first region exceeds the first regional threshold is not greater than the count threshold, updating the current image frame and a subsequent image frame among the plurality of image frames as a new previous image frame and a new current image frame, respectively; and (F) repeating steps (A), (B), (C), (D), and (E) on the new current image frame and the new previous image frame until, for all corresponding image frames, the number of times that the maximum value of the first region exceeds the first regional threshold is greater than the count threshold, and, in turn, providing the alert means.

Optionally, the motion detection method may further comprise the following step: prior to generating the vector matrix, converting both the current image frame and the previous image frame into grayscale images.

Optionally, in the motion detection method, the vector matrix may comprise only the first region.

Optionally, in the motion detection method, the vector matrix may further comprise a second region in addition to the first region, and the second region may correspond to a second regional threshold. The first regional threshold and the second regional threshold may be different. The motion detection method may further comprise the following steps: determining a maximum value of the second region, comparing the maximum value of the second region with the second regional threshold, providing the alert means when a total number of times the maximum value of the first region exceeds the first regional threshold and a number of times the maximum value of the second region exceeds the second regional threshold, is greater than the count threshold.

Optionally, the motion detection method may further comprise the following steps: receiving a set of control signals from an external device, and determining the first regional threshold, the second regional threshold, and the count threshold based on the set of control signals.

Optionally, the motion detection method may further comprise the step of determining a partitioning manner of the first region and the second region based on the set of control signals.

Optionally, the motion detection method may further comprise the following steps: receiving a set of control signals from an external device and determining the first regional threshold and the count threshold based on the set of control signals.

Optionally, in the motion detection method, the alert means may be an audible buzzer alert.

Optionally, in the motion detection method, the alert means may be an alert signal, and the motion detection method may further comprise the step of transmitting the alert signal to an external device and have the external device alert a user of the external device accordingly.

Optionally, in the motion detection method, the alert means may be a light-based alert.

In order to at least solve the above technical problems, the present disclosure further provides a non-transitory machine-readable medium storing instructions that, when executed by a machine (e.g., a computer), cause the machine to perform any of the motion detection methods described above.

Based on the above, the motion detection solution of the present disclosure performs a downscaling process on image frames to be processed before performing optical flow computation. This reduces the hardware resources required by the motion detection device during motion detection, thereby alleviating the processing burden on the memory and the processor of the motion detection device. In addition, the motion detection solution of the present disclosure adopts an optical flow algorithm to perform motion detection computation, which enables better real-time processing of object motion information, allows the device to capture more detailed information of the detected object (for example, but not limited to, the moving direction and moving speed of the object), and further improves the accuracy and reliability of motion detection. Accordingly, the present disclosure effectively reduces the demand of hardware specifications and resource consumption of motion detection device during motion detection, achieves efficient utilization of computing resources and optimization of motion detection performance, and provides a superior motion detection effect.

The above description is not intended to limit the present disclosure but merely provides a general overview of the technical problems that can be solved by the present disclosure, the technical means that can be adopted, and the technical effects that can be achieved, so that those skilled in the art may gain a preliminary understanding of the present disclosure. Based on the attached drawings and the contents described in the following embodiments, those skilled in the art can further understand various embodiments of the present disclosure.

### BRIEF DESCRIPTION OF DRAWINGS

FIG. 1 is a schematic diagram of a motion detection device according to one or more embodiments of the present disclosure.

FIG. 2 is a flowchart illustrating motion detection performed by the motion detection device according to one or more embodiments of the present disclosure.

FIG. 3A is a schematic diagram of one image frame among continuous images during motion detection performed by the motion detection device according to one or more embodiments of the present disclosure.

FIG. 3B is a schematic diagram of a partial of vector matrix generated during motion detection performed by the motion detection device according to one or more embodiments of the present disclosure.

FIG. 4 is a flowchart illustrating a motion detection method according to one or more embodiments of the present disclosure.

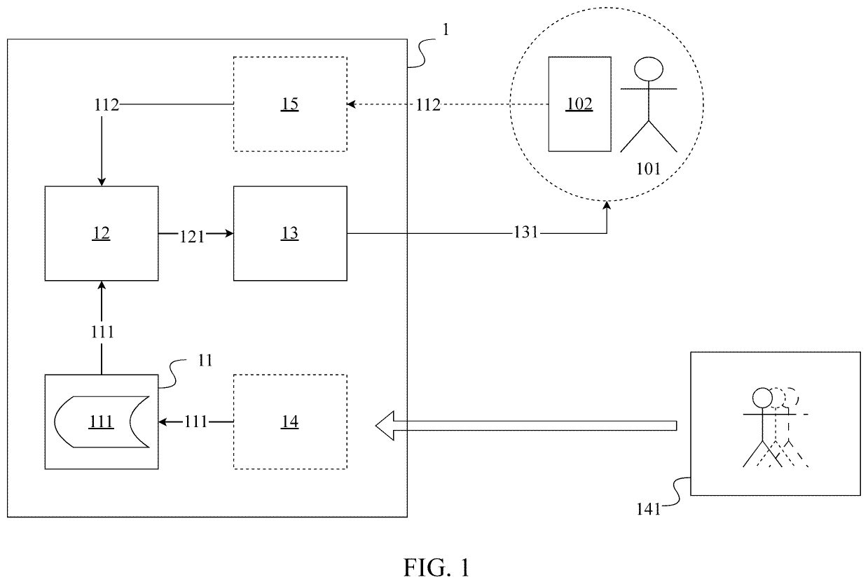

The content shown in FIGS. 1-4 is provided merely as examples for illustrating embodiments of the present disclosure and is not intended to limit the scope of the present disclosure.

### DETAILED DESCRIPTION OF THE INVENTION

The following embodiments are not intended to limit the claimed invention to a specific environment, application, structure, process, or situation. The attached drawings are only used to assist in explaining the embodiments disclosed below, and are not intended to limit the scope claimed in the present disclosure. For example, in the attached drawings, elements unrelated to the claimed invention are omitted. The dimensions of individual elements and their relative proportions are merely illustrative, and are not intended to limit the claimed invention. The same element symbols in the following description may refer to the same elements, unless otherwise specified.

Terms such as “a” or “an” are not intended to limit quantity, and should be regarded as encompassing embodiments that include a plurality of the same referents. Terms such as “comprising,” “including,” and “having” are used to illustrate the existence of features, integers, steps, operations, elements, components and/or groups stated after the terms, but do not exclude the presence or addition of one or more other additional features, integers, steps, operations, elements, components and/or groups thereof. The term “and/or” is used to represent any one or various permutations and combinations of one or more associated items listed. Terms such as “first,” “second,” and “third” used to describe features, integers, steps, operations, elements, components and/or groups are not intended to limit the order of these described objects, but are only used to distinguish them.

A first embodiment of the present disclosure is a motion detection device for continuous images. Referring to FIG. 1, a motion detection device 1 according to one or more embodiments of the present disclosure is illustrated. The motion detection device 1 may be implemented as any type of electronic device having image processing functionality, for example, but not limited to, an Internet Protocol (IP) camera, a camera, a smartphone, a tablet computer, smart glasses, or a head-mounted device for virtual, augmented, or mixed reality. These electronic devices can perform image data processing on continuous images (for example, a video, a motion image, and the like) related to a target object in their application environment, thereby to perform motion detection on the target object.

The motion detection device 1 may at least comprise a storage 11, a processor 12, and an alert unit 13. The storage 11 may be electrically coupled with the processor 12 and the alert unit 13 through either a direct electrical connection (i.e., without intervening components) or an indirect electrical connection (i.e., through intervening components).

The storage 11 may store data generated by the motion detection device 1, data received from an external device, and/or data generated by a user via input/output components (for example, a combination of a keyboard, a mouse, a touch panel, a display, and the like). For example, the storage 11 may include a first-level memory (also referred to as main memory or internal memory). The processor 12 may directly read instruction sets stored in the first-level memory and execute them as needed. The storage 11 may also include a second-level memory (also referred to as external memory or auxiliary memory), which may transfer stored data to the first-level memory through a data buffer. The second-level memory may be, for example, but not limited to, a hard disk, an optical disk, or other storage media. The storage 11 may further include a third-level memory, such as a removable storage device or a cloud drive. Depending on application requirements, the storage 11 may comprise the first-level memory, the second-level memory, and/or the third-level memory.

As described above, the motion detection device 1 is configured to process continuous images. Therefore, the storage 11 shown in FIG. 1 may store a set of continuous images 111. The set of continuous images 111 may include a plurality of sequentially related image frames, and each image frame may serve as a basis for motion detection performed by the motion detection device 1. The set of continuous images 111 may be, for example, a segment of a surveillance video recorded by an IP camera, or a segment of video recorded by a camera.

The processor 12 may be a programmable application-specific integrated circuit (ASIC) having capabilities such as computation, storage, input/output, etc., may accept and process various encoded instructions to perform logical and arithmetic operations, and output corresponding results. The processor 12 may be programmed to interpret various instructions to execute tasks or programs, and thereby implement the processes described in the present disclosure. For example, the processor 12 may include a Central Processing Unit (CPU), a Graphics Processing Unit (GPU), a Digital Signal Processor (DSP), a microprocessor, and/or a microcontroller. Overall, the processor 12 may determine whether a motion event occurs in a specific region of the image frame based on the plurality of image frames stored in the storage 11.

The alert unit 13 may be any type of component having alert features, thereby providing an alert means 131 to a user 101 and/or an external device 102. More specifically, when the processor 12 determines that a motion event has occurred, the alert unit 13 may provide the alert means 131 to the user 101 and/or the external device 102 to notify them of the occurrence of the motion event. The alert unit 13 may have a corresponding hardware structure that adapts to various means to present the alert.

For example, in some embodiments, the alert means 131 may be a sound-based alert, and the alert unit 13 may therefore be a buzzer or a speaker that provides an alert via a buzzer sound, an audio effect, and/or a voice message. In some embodiments, the alert means 131 may be a light-based alert, and the alert unit 13 may therefore include at least one indicator light that provides an alert via turning the light signals on and off.

In some embodiments, the alert means 131 may be a display-based alert, and the alert unit 13 may be a display that presents an alert using content visible to the user 101.

In some embodiments, the alert means 131 may be a communication-based alert, and the alert unit 13 may be a transceiver that sends packets carrying an alert message to an external device 102 to convey the alert. The external device 102 may be, for example but not limited to, a smartphone, a laptop computer, a desktop computer, a television, or another electronic device. The transceiver may include a transmitter and a receiver. In the case of wireless communication, the transceiver may include, but is not limited to, an antenna, an amplifier, a modulator, a demodulator, a detector, an analog-to-digital converter, a digital-to-analog converter, and other communication components. In the case of wired communication, the transceiver may include, for example but not limited to, a gigabit Ethernet transceiver, a gigabit interface converter (GBIC), a small form-factor pluggable (SFP) transceiver, or a ten-gigabit small form-factor pluggable (XFP) transceiver. Specifically, the motion detection device 1 may provide the alert message to the external device 102 through the transceiver to achieve the alert effect.

It should be noted that the various types of alert means 131 described above may, in some embodiments, coexist in combination, in addition to being individually provided, thereby achieving a more comprehensive alert effect. In this case, the alert unit 13 may be a collection of hardware structures corresponding to the various alert means 131 described above. Those having ordinary skill in the art can understand, based on the above description of the alert unit 13, how the hardware structures corresponding to multiple alert means 131 may coexist and cooperate, and therefore, further details are omitted herein.

In some embodiments, the motion detection device 1 may further include an image capture unit 14 electrically coupled to the storage 11 and the processor 12, and may be configured to capture images to generate the aforementioned set of continuous images 111. More specifically, the image capture unit 14 may refer to a collection of components including at least one lens, a photosensitive element, a lens controller, etc. The lens controller may control the operation of each lens (for example, according to instructions from the processor 12) to form an image on the photosensitive element.

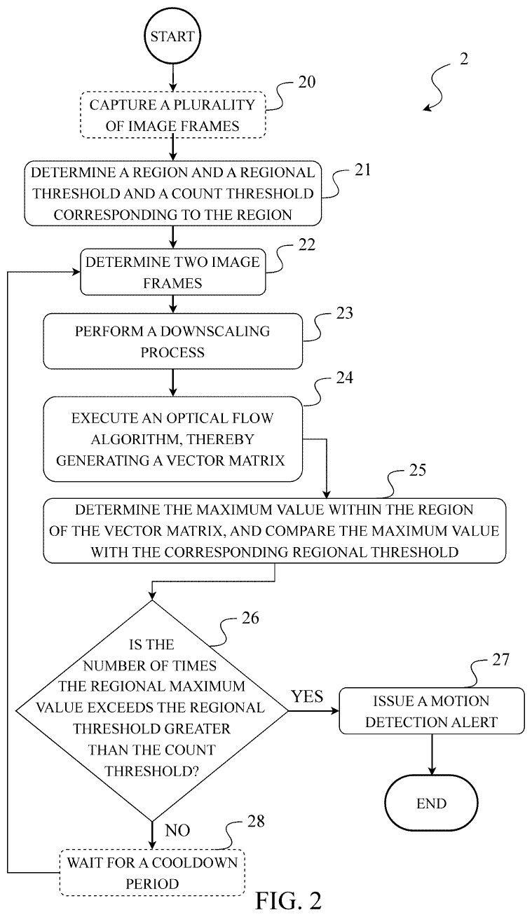

Referring to FIG. 2, a motion detection process 2 performed by the motion detection device 1 according to one or more embodiments of the present disclosure is shown. In some embodiments, the motion detection process 2 may begin with operation 20, in which the motion detection device 1 may capture a plurality of image frames of a shooting target 141 using, for example, the aforementioned image capture unit 14, and store them in the storage 11. The plurality of image frames may be, for example, the multiple frames of the set of continuous images 111 shown in FIG. 1. In some other embodiments, the motion detection device 1 may also acquire the plurality of image frames using, for example, a transceiver or input/output (I/O) components. It should be understood that the description of the number of image frames in the continuous image in FIG. 1 and herein is merely exemplary and not limiting.

Next, in operation 21, the processor 12 may determine a region for motion detection from the plurality of image frames, a regional threshold corresponding to the region, and a count threshold corresponding to the region. In some embodiments, the motion detection process 2 may also begin directly with operation 21. The region may be a key area that the user 101 and/or the manufacturer of the motion detection device 1 considers necessary for motion detection. The processor 12 may determine the count threshold, the region, and the regional threshold based on instructions from the user 101 or data predetermined by the manufacturer or administrator.

In some embodiments, attention to the entire image frame during monitoring may not be desired in some implemented scenarios. For example, a user with parental needs may only wish to monitor the region showing a crib in a surveillance image for motion events and may not consider movements outside the window, such as birds flying by, as meaningful motion events. Therefore, some embodiments of the present disclosure allow the user and/or an administrator to define each image frame to include at least one region and to set a detection sensitivity for each region. The regional threshold represents the detection sensitivity of the region with respect to the movement of individual parts (for example, pixels). The count threshold represents the threshold for the overall number of potential motion occurrences of all parts in the region. Together, these thresholds indicate the motion detection sensitivity of the region. Further details will be described later.

The partitioning manner of regions in each image frame may be the same to facilitate subsequent calculations by the processor 12. In some embodiments, the partitioning manner may be specified by the user 101 (for example, by providing instructions through an input/output component or via a transceiver). For example, the user 101 may determine the partitioning manner through the user interface of their mobile device and provide corresponding instructions to the motion detection device 1. Therefore, in embodiments where the partitioning manner is specified by the user 101, as shown in FIG. 1, the motion detection device 1 may further include a transceiver 15 electrically coupled to the processor 12 to receive a control signal 112 from an external device 102. The control signal 112 may be used to specify the count threshold, the partitioning manner of the image frames, and the regional thresholds corresponding to each region (for example, the aforementioned first regional threshold). However, in some other embodiments, the partitioning manner may be predetermined in a built-in firmware and/or software of the motion detection device 1 by the manufacturer or administrator.

As described above, in some embodiments, the alert means 131 may be a communication-based alert, and the alert unit 13 may be a transceiver. In these embodiments, if the motion detection device 1 further includes the transceiver 15, the alert unit 13 and the transceiver 15 may be integrated into a single component.

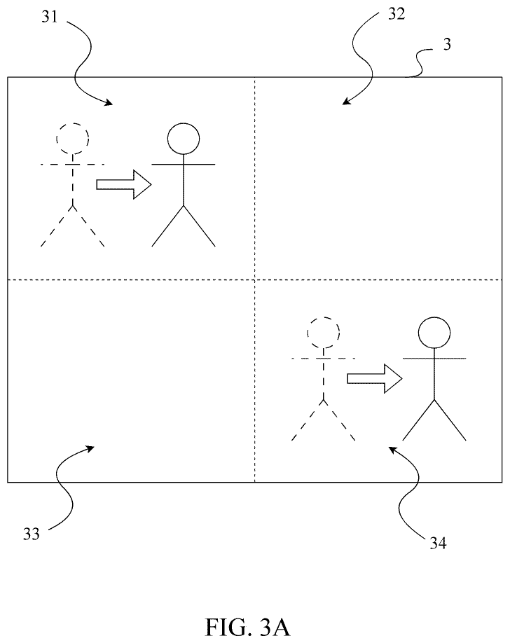

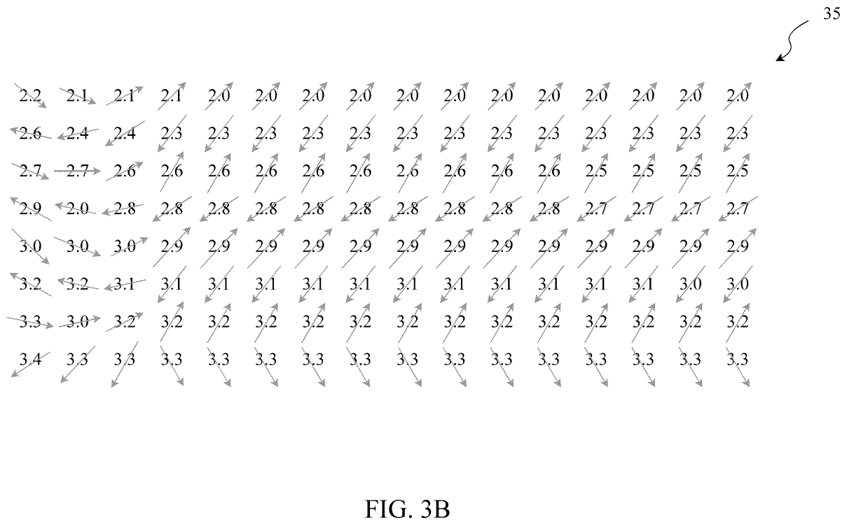

A more specific embodiment of region partitioning can be seen in FIG. 3A, which illustrates one image frame 3 of the set of continuous images for motion detection performed by the motion detection device 1 according to one or more embodiments of the present disclosure. The image frame 3 may correspond to one of the image frames in the set of continuous images 111 shown in FIG. 1. It should be understood that the content shown in FIG. 3A is provided merely for illustrative purposes and does not intend to limit the content or region partitioning scheme for the images. As shown in FIG. 3A, the image frame 3 may be partitioned into four regions, namely region 31, region 32, region 33, and region 34, and this manner of region partitioning may be defined by the user 101 or an administrator.

Referring back to FIG. 2, after the count threshold, the region-partitioning results, and the regional thresholds for each region are determined, operation 22 may be performed. Here, the processor 12 may determine two image frames among the acquired plurality of image frames for processing, namely a previous image frame and a current image frame. For real-time motion detection, these two image frames are preferably two temporally adjacent frames within the plurality of image frames, so that a motion event can be detected within the shortest possible time interval.

In operation 23, the processor 12 may perform a downscaling process on the two image frames, thereby reducing the computational burden on the processor 12. The downscaling process may include, but is not limited to, nearest-neighbor interpolation, bilinear interpolation, or the like. For example, after the downscaling process, the file size of each image frame may be reduced to approximately one-half of its original size. In certain embodiments, in addition to the downscaling process, the processor 12 may further convert the two image frames into grayscale images, thereby further reducing the consumption of computational resources by the processor 12.

In operation 24, the processor 12 may execute an optical flow algorithm and generate a vector matrix corresponding to the two image frames. The distribution of regions in the vector matrix may correspond to the above-described regional partitioning of the image frames. For example, the image frame 3 illustrated in FIG. 3A is partitioned into four equal regions in a cross cut, and the vector matrix generated by the optical flow algorithm is similarly partitioned into four equal regions in a cross cut, where the values in each region are used to describe the respective regions in the image frame.

The optical flow algorithm is a motion detection technique based on analysis of a sequence of images, and is widely applied in motion detection and object tracking. Its basic principle is to estimate the movement direction and speed of objects by analyzing changes of significant feature points in consecutive image frames. The optical flow algorithm primarily relies on two fundamental concepts: brightness constancy and small-motion assumption. The brightness constancy presumes that the brightness of feature points does not change between consecutive frames during object movement. The small-motion assumption presumes that the movement of each feature point is minor over a short period of time. Therefore, by analyzing the feature points between consecutive frames, the movement direction and magnitude for each feature point can be derived. With the optical flow algorithm, the processor 12 can identify the feature points between the two image frames, analyze the changes of these feature points, and generate a vector matrix containing the motion direction and the motion magnitude of the feature points.

A specific example of a portion of the vector matrix is illustrated in FIG. 3B. Referring to FIG. 3B, it exemplifies a matrix 35 with a size of 8×16. The matrix 35 can represent a portion of the vector matrix (i.e., a sub-matrix of the vector matrix). More specifically, the vector matrix may represent every pixel of the entire image frame 3, and the matrix 35 can represent one region within the image frame 3, for example but not limited to the region 31 as previously described in FIG. 3A. The region 31 can represent areas within the entire image that the user intends to monitor for potential motion events.

In the matrix 35 shown in FIG. 3B, each element includes a value and a direction (i.e., a vector). The value represents the magnitude of motion, that is, the displacement of the feature point between the two consecutive image frames. The direction represents the motion direction of the displacement. In certain embodiments, if the displacement in the X direction is dx and the displacement in the Y direction is dy, then the motion magnitude can be \sqrt{dx²+dy²}, and the angle representing the motion direction can be

$${tan}^{- 1} ( \frac{dy}{dx} ) .$$

It should be understood that the matrix 35 shown in FIG. 3B is merely illustrative. Those of ordinary skill in the art should be able to readily understand how to maintain the information regarding motion magnitude and motion direction in FIG. 3B by implementing, for example, a one-dimensional array, a two-dimensional array, or other data structures. Therefore, further details are omitted herein.

Referring simultaneously to FIGS. 2, 3A, and 3B, in operation 25, the processor 12 may determine a maximum value of each region of the vector matrix generated in operation 24, compare the maximum value of each region with a corresponding regional threshold, and record the number of times, for each region, where the maximum value exceeds its corresponding regional threshold. As described above, the regional threshold for each region is independent from each other, meaning each region can have a different detection sensitivity. In certain embodiments, the processor 12 may set a sensitivity level from 1 to 5 (where 1 is the most sensitive and 5 is the least sensitive) and set the regional thresholds corresponding to sensitivity levels 1, 2, 3, 4, and 5, respectively, as, for example (but not limited to), 2.0, 4.0, 8.0, 12.0, and 20.0.

Taking FIG. 3A as an example, the user 101 may define the upper-left region 31 as the most important region of interest, and accordingly have the highest relative detection sensitivity. For example, the region 31 may have a regional threshold of 2.0 and a count threshold of 1. Similarly, the user 101 may also define region 34 as the second-priority region of interest and accordingly have a relatively high detection sensitivity. For example, the region 34 may has a regional threshold of 8.0 and a count threshold of 3. It should be noted that regions with higher detection sensitivity may have lower regional thresholds and/or count thresholds, meaning they are more likely to be determined by the processor 12 to have potential motion. Regions 32 and 33 may be considered less important regions and are thus defined with relatively lower detection sensitivity by the user 101. For example, regions 32 and 33 may have a regional threshold of 20.0 and a count threshold of 5, or, in some cases, the processor 12 may not perform motion detection on them at all, thereby saving more computational resources. The following description will use region 31 as an example for describing the embodiments of the present disclosure.

In operation 26, for the maximum value of each region corresponding to region 31 determined in operation 25, the processor 12 may determine whether the number of times the maximum value of region 31 exceeds the corresponding regional threshold surpasses the count threshold (e.g., 5 times). If the determination in operation 26 is “yes,” it indicates that the processor 12 has detected a motion event in region 31. Accordingly, in operation 27, the processor 12 may issue a motion detection alert, specifically a motion detection signal 121, to the alert unit 13, and cause the alert unit 13 to provide at least one of the aforementioned alert means 131 based on the motion detection signal 121. Conversely, if the determination in operation 26 is “no,” it indicates that the processor 12 has not yet detected a sufficient number of potential motion events in region 31, and motion detection may be continued. The processor 12 may repeat operations 22, 23, 24, 25, and 26 until, for all the corresponding image frames, the number of times the maximum value of the first region exceeds the first regional threshold surpasses the count threshold, at which point the alert means 131 is then provided.

In certain embodiments, the processor 12 may, in operation 28, wait for a cooldown period before re-executing operations 22, 23, 24, 25, and 26. The cooldown period can be set, for example, between 400 milliseconds and 600 milliseconds, such as, in a preferred embodiment, 500 milliseconds. However, in other embodiments, the processor 12 may re-execute operations 22, 23, 24, 25, and 26 directly without waiting for the cooldown period.

When the processor 12 re-executes operation 22, the original current image frame can be updated as the previous image frame, and the image frame, among the plurality of image frames, following the original current image frame in temporal sequence can be used as the new current image frame, and then operations 23, 24, 25, and 26 can be continued. The number of times the maximum value of the first region exceeds the first regional threshold calculated for region 31 at previous round(s) of operation 25 can be maintained and will not be reset to zero. In addition to the aforementioned region 31, the processor 12 can perform the same operations for other regions shown in FIG. 3A and perform motion detection on these regions.

In some embodiments, the processor 12 may also perform motion detection for the entire image frame in a similar manner as described above with respect to region 31. In other words, each image frame may contain only a single region, and the processor 12 can perform motion detection by determining a maximum value from the entire vector matrix, comparing the maximum value with the regional threshold, and determining whether the number of times the maximum value exceeds the regional threshold reaches the count threshold.

In some embodiments, the count threshold may instead be compared with a total number of times the maximum value exceeding the regional threshold corresponding to all regions (or all regions intended for motion detection). That is, the count threshold may be compared with the total number of times that the maximum values in respective regions of the vector matrix exceed their respective regional thresholds. In such embodiments, the processor 12 can comprehensively consider the occurrence of potential motion across the regions, and issue a motion detection alert signal to the alert unit 13 only after a certain level of potential motion has appeared collectively in these regions. Though not illustrated in FIG. 2, by increasing the number of regions considered during comparison with the count threshold, overly frequent and/or false alerts can be avoided.

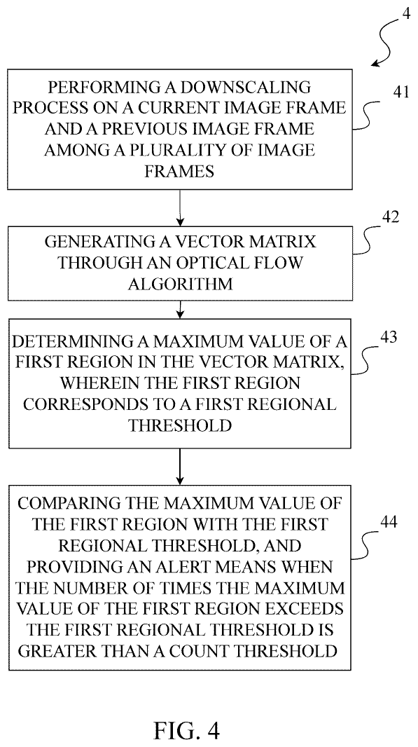

The second type of embodiment of the present disclosure is a motion detection method. Referring to FIG. 4, it illustrates a motion detection method 4 according to one or more embodiments of the present disclosure. The motion detection method 4 can be executed by an electronic device (for example, but not limited to, the motion detection device 1 described above), and can include the following steps performed by the electronic device on a current image frame and a previous image frame among multiple image frames: (A) performing a downscaling process (denoted as step 41); (B) generating a vector matrix through an optical flow algorithm (denoted as step 42); (C) determining a maximum value of a first region in the vector matrix, wherein the first region corresponds to a first regional threshold (denoted as step 43); and (D) comparing the maximum value of the first region with the first regional threshold, and providing an alert means when the number of times the maximum value of the first region exceeds the first regional threshold is greater than a count threshold (denoted as step 44).

In some embodiments, the motion detection method 4 may further comprise the following steps: (E) when the number of times the maximum value of the first region exceeds the first regional threshold is not greater than the count threshold, updating the current image frame and a subsequent image frame following the current image frame among the plurality of image frames as a new previous image frame and a new current image frame, respectively; and (F) repeating the steps (A), (B), (C), (D), and (E) on the new current image frame and the new previous image frame until, for all corresponding image frames, the number of times that the maximum value of the first region exceeds the first regional threshold is greater than the count threshold, and, in turn, providing the alert means.

In some embodiments, the motion detection method 4 may further comprise the step of converting both the current image frame and the previous image frame into grayscale images prior to generating the vector matrix.

In some embodiments, regarding the motion detection method 4, the vector matrix may comprise only the first region.

In some embodiments, regarding the motion detection method 4, the vector matrix may comprise not only the first region but also a second region, the second region may correspond to a second regional threshold, and the first regional threshold and the second regional threshold may be different. In addition, the motion detection method 4 may further comprise the following steps: for the second region, determining a corresponding maximum value of the second region, and comparing the maximum value of the second region with the second regional threshold, wherein the electronic device is configured to provide the alert means when a total number of times the maximum value of the first region exceeds the first regional threshold and a number of times the maximum value of the second region exceeds the second regional threshold exceeds the count threshold.

In some embodiments, the motion detection method 4 may further comprise the steps of: receiving a set of control signals from an external device; and determining the first regional threshold, the second regional threshold, and the count threshold based on the set of control signals. The user of the external device can adjust the first regional threshold, the second regional threshold, and the count threshold at any time via the external device to determine the motion detection sensitivity at the first and second regions.

In some embodiments, the motion detection method 4 may further comprise the step of determining the partitioning manner of the first region and the second region based on the set of control signals.

In some embodiments, the motion detection method 4 may further comprise the steps of: receiving a set of control signals from an external device, determining the first regional threshold and the count threshold according to the set of control signals. The user of the external device can adjust the first regional threshold and the count threshold at any time via the external device to determine the motion detection efficiency at the first region.

In some embodiments, regarding the motion detection method 4, the alert means may be an audible buzzer alert.

In some embodiments, regarding the motion detection method 4, the alert means may be an alert signal, and the motion detection method 4 may further comprise the step of transmitting the alert signal to an external device and have the external device alerting its user accordingly.

In some embodiments, regarding the motion detection method 4, the alert means may be a light-based alert.

Each embodiment of motion detection method 4 generally corresponds to a respective embodiment of the motion detection device 1. Therefore, based solely on the foregoing description of motion detection device 1, a person having ordinary skill in the art would be able to fully understand and implement all corresponding embodiments of motion detection method 4, even if detailed description of embodiments from the motion detection method 4 has been omitted.

The third type of embodiment of the present invention involves a computer program product storing a program for motion detection on continuous images. When an electronic computing device (e.g., a computer) loads and executes the program, the multiple program instructions included in the computer program product can execute the motion detection method 4 described above with respect to the second type of embodiment. The computer program product can be stored on a non-transitory tangible machine-readable medium, such as, but not limited to, a Read-Only Memory (ROM), Flash Memory, a disk, a mobile hard drive, a magnetic tape, a network-accessible database, or any other storage medium with equivalent functionality known to a person having ordinary skill in the art.

As described above, the motion detection solution provided by the present disclosure performs a downscaling process on the image frames intended for motion detection. This reduces the hardware resources required by the motion detection device during motion detection and lowers the computational load on the hardware. In addition, the motion detection solution of the present disclosure employs an optical flow algorithm to perform motion detection calculations. This enables more effective real-time processing of object motion information, captures more detailed information about the detected objects, and further improves the accuracy and reliability of motion detection. Accordingly, the present disclosure effectively reduces the requirements for hardware specifications and resources for the motion detection device when performing motion detection.

The above embodiments are only examples for illustrating the embodiments of the present disclosure and are not intended to limit the scope claimed in the present disclosure. Any other embodiments produced by modifying, changing, adjusting and integrating the above-mentioned embodiments shall all be included in the scope claimed in the present disclosure as long as they are not difficult for those of ordinary skill in the art to contemplate. The scope claimed in the present disclosure shall be governed by the claims.

1. A motion detection device, comprising:
a storage configured to store a plurality of image frames;
an alert unit; and
a processor electrically coupled to the storage and the alert unit, configured to perform the following operations on a current image frame and a previous image frame among the plurality of image frames:
(A) performing a downscaling process;
(B) generating a vector matrix through an optical flow algorithm;
(C) determining a maximum value of a first region in the vector matrix, wherein the first region corresponds to a first regional threshold; and
(D) comparing the maximum value of the first region with the first regional threshold, and transmitting a motion detection signal to the alert unit when a number of times the maximum value of the first region exceeds the first regional threshold is greater than a count threshold;
wherein the alert unit is configured to provide an alert means based on the motion detection signal.

2. The motion detection device of claim 1, wherein the processor is further configured to perform the following operations:
(E) when the number of times the maximum value of the first region exceeds the first regional threshold is not greater than the count threshold, updating the current image frame and a subsequent image frame that follows the current image frame among the plurality of image frames as a new previous image frame and a new current image frame, respectively; and
(F) repeating operations (A), (B), (C), (D) and (E) on the new current image frame and the new previous image frame until, for all corresponding image frames, the number of times that the maximum value of the first region exceeds the first regional threshold is greater than the count threshold, and, in turn, transmitting the motion detection signal to the alert unit.

3. The motion detection device of claim 1, wherein the processor is further configured to convert, prior to generating the vector matrix, both the current image frame and the previous image frame into grayscale images.

4. The motion detection device of claim 1, wherein the vector matrix comprises only the first region.

5. The motion detection device of claim 1, wherein:
the vector matrix further comprises a second region in addition to the first region, and the second region corresponds to a second regional threshold; and
the processor is further configured to determine a maximum value of the second region, compare the maximum value of the second region with the second regional threshold, transmit the motion detection signal to the alert unit when a total number of times the maximum value of the first region exceeds the first regional threshold and a number of times the maximum value of the second region exceeds the second regional threshold is greater than the count threshold.

6. The motion detection device of claim 5, further comprising a transceiver, wherein:
the transceiver is electrically coupled to the processor;
the transceiver is configured to receive a set of control signals from an external device; and
the processor is further configured to determine the first regional threshold, the second regional threshold, and the count threshold based on the set of control signals.

7. The motion detection device of claim 6, wherein the processor is further configured to determine a partitioning manner of the first region and the second region based on the set of control signals.

8. The motion detection device of claim 1, further comprising a transceiver, wherein:
the transceiver is electrically coupled to the processor;
the transceiver is configured to receive a set of control signals from an external device; and
the processor is further configured to determine the first regional threshold and the count threshold based on the set of control signals.

9. The motion detection device of claim 1, wherein the alert unit is a buzzer, and the alert means is an audible buzzer alert.

10. The motion detection device of claim 1, wherein the alert unit is a transceiver, the alert means is an alert signal, and the transceiver is configured to transmit the alert signal to an external device and have the external device alert a user of the external device accordingly.

11. The motion detection device of claim 1, wherein the alert unit comprises at least one indicator light, and the alert means is a light-based alert.

12. A motion detection method applied to continuous images, executed by an electronic device, the motion detection method comprising performing the following steps on a current image frame and a previous image frame among a plurality of image frames:
(A) performing a downscaling process;
(B) generating a vector matrix through an optical flow algorithm;
(C) determining a maximum value of a first region in the vector matrix, wherein the first region corresponds to a first regional threshold; and
(D) comparing the maximum value of the first region with the first regional threshold and providing an alert means when a number of times the maximum value of the first region exceeds the first regional threshold is greater than a count threshold.

13. The motion detection method of claim 12, further comprising the following steps:
(E) when the number of times the maximum value of the first region exceeds the first regional threshold is not greater than the count threshold, updating the current image frame and a subsequent image frame following the current image frame among the plurality of image frames as a new previous image frame and a new current image frame, respectively; and
(F) repeating the steps (A), (B), (C), (D), and (E) on the new current image frame and the new previous image frame until, for all corresponding image frames, the number of times that the maximum value of the first region exceeds the first regional threshold is greater than the count threshold, and, in turn, providing the alert means.

14. The motion detection method of claim 12, further comprising the following step:
prior to generating the vector matrix, converting both the current image frame and the previous image frame into grayscale images.

15. The motion detection method of claim 12, wherein the vector matrix comprises only the first region.

16. The motion detection method of claim 12, wherein:
the vector matrix further comprises a second region in addition to the first region, and the second region corresponds to a second regional threshold;
the first regional threshold and the second regional threshold are different; and
the motion detection method further comprises the following steps: determining a maximum value of the second region, comparing the second regional maximum value of the second region with the second regional threshold, providing the alert means when a total number of times the maximum value of the first region exceeds the first regional threshold and a number of times the maximum value of the second region exceeds the second regional threshold, is greater than the count threshold.

17. The motion detection method of claim 16, further comprising the following steps:
receiving a set of control signals from an external device; and
determining the first regional threshold, the second regional threshold, and the count threshold based on the set of control signals.

18. The motion detection method of claim 17, further comprising the following step:
determining a partitioning manner of the first region and the second region based on the set of control signals.

19. The motion detection method of claim 12, further comprising the following step:
receiving a set of control signals from an external device; and
determining the first regional threshold and the count threshold based on the set of control signals.

20. The motion detection method of claim 12, wherein the alert means is an audible buzzer alert.

21. The motion detection method of claim 12, wherein the alert means is an alert signal, and the motion detection method further comprises the step of transmitting the alert signal to an external device and have the external device alert a user of the external device accordingly.

22. The motion detection method of claim 12, wherein the alert means is a light-based alert.

23. A non-transitory machine-readable medium storing instructions that, when executed by a machine, cause the machine to perform the motion detection method of claim 12.
